(19) United States
(12) Patent Application Publication
(10) Pub. No.: US 2026/0088883 A1
(43) Pub. Date: Mar. 26, 2026

(54) TRANSMISSION USER EQUIPMENT SIDELINK BEAM DETECTION AND RECOVERY

(71) Applicant: Apple Inc., Cupertino, CA (US)

(72) Inventors: Peng Cheng, Beijing (CN); Fangli Xu, Beijing (CN); Haijing Hu, Los Gatos, CA (US); Naveen Kumar R. Palle Venkata, San Diego, CA (US); Ping-Heng Kuo, London (GB); Ralf Rossbach, Munich (DE); Zhibin Wu, Los Altos, CA (US)

(21) Appl. No.: 19/111,364

(22) PCT Filed: Sep. 15, 2023
(86) PCT No.: PCT/US2023/032879

§ 371 Date: Mar. 13, 2025

Related U.S. Application Data
(60) Provisional application No. 63/407,612, filed on Sep. 16, 2022.

(51) Int. Cl. H04B 7/06; H04B 17/318; H04W 72/25

(52) U.S. Cl. CPC H04B 7/06952; H04B 17/328; H04W 72/25

(57) ABSTRACT

Methods, systems, apparatuses, and computer programs for establishing a communication link are disclosed. In one aspect, the method can include transmitting, by a first UE, a direct communication request to a second UE using a preconfigured set of transmission serving beams, receiving, by the first UE, a direct security mode message from the second UE, wherein the direct security mode message was transmitted, by the second UE, using a resource associated with a particular transmission serving beam of the set of transmission serving beams, and transmitting, by the first UE, a transmission using a transmission serving beam based on the resource associated with the particular transmission serving beam.

### CLAIM OF PRIORITY

The present application claims priority to U.S. Provisional Patent Application No. 63/407,612, filed on Sep. 16, 2022, entitled “TRANSMISSION USER EQUIPMENT SIDELINK BEAM DETECTION AND RECOVERY,” which is herein incorporated by reference in its entirety.

### BACKGROUND

In some wireless communications networks, a user equipment (UE) may communicate with another UE without having the communication routed through a network node, using what is referred to as sidelink communication. A transmitting UE that wants to initiate sidelink communication may determine the available resources (e.g., sidelink resources) and may select a subset of these resources to communicate with a receiving UE based on a resource allocation scheme.

### SUMMARY

According to one innovative aspect of the present disclosure, another method for establishing a communication link is disclosed. In one aspect, the method can include transmitting, by a first UE, a direct communication request to a second UE using a preconfigured set of transmission serving beams, receiving, by the first UE, a direct security mode message from the second UE, wherein the direct security mode message was transmitted, by the second UE, using a resource associated with a particular transmission serving beam of the set of transmission serving beams selected by the second UE, determining, by the first UE, a transmission serving beam based on the resource associated with the particular transmission serving beam and used to receive the direct security mode message, and transmitting, by the first UE, a transmission using the determined transmission serving beam.

Other aspects includes apparatuses, systems, and computer programs for performing the actions of the aforementioned method.

The innovative method can include other optional features. For example, in some implementations, an association between the preconfigured set of transmission serving beams and a resource used, by the first UE, to receive direct communication acceptance is preconfigured.

In some implementations, the particular transmission serving beam of the set of transmission serving beams selected by the second UE is selected based on a sidelink reference signal received power (RSRP) associated with each of the transmission serving beams.

In some implementations, the particular transmission serving beam of the set of transmission serving beams selected by the second UE is selected based on the particular transmission serving beam having the best sidelink reference signal received power (RSRP).

According to another innovative aspect of the present disclosure, a method for establishing a communication link. In one aspect, the method can include receiving, by a first UE, a direct communication request transmitted by a second UE using a preconfigured set of transmission serving beams, selecting, by the first UE, a particular transmission serving beam from a set of transmission serving beams for use in transmitting a direct security mode message to the second UE, and transmitting, by the first UE, the direct security mode message to the second UE using a resource associated with the selected transmission serving beam, wherein the second UE is configured to determine a transmission serving beam based on the resource used, by the first UE, to transmit the direct security mode message.

Other aspects includes apparatuses, systems, and computer programs for performing the actions of the aforementioned method.

The innovative method can include other optional features. For example, in some implementations, an association between the preconfigured set of transmission serving beams and a resource used, by the second UE, to receive direct communication acceptance is preconfigured.

In some implementations, selecting, by the first UE, a particular transmission serving beam from a set of transmission serving beams for use in transmitting a direct security mode message to the second UE can include selecting, by the first UE, a particular transmission serving beam from the set of transmission serving beams for use in transmitting the direct security mode message based on a sidelink reference signal received power (RSRP) associated with each of the transmission serving beams.

In some implementations, selecting, by the first UE, a particular transmission serving beam from a set of transmission serving beams for use in transmitting a direct security mode message to the second UE can include selecting, by the first UE, a particular transmission serving beam from the set of transmission serving beams for use in transmitting the direct security mode message based on the particular transmission serving beam having the best sidelink reference signal received power (RSRP).

According to another innovative aspect of the present disclosure, a method for establishing a communication link is disclosed. In one aspect, the method can include transmitting, by a first UE, a unicast packet to a second UE using a preconfigured set of transmission serving beams, receiving, by the first UE, at least one ACK or NACK from the second UE in a physical sidelink feedback channel (PSFCH), and transmitting, by the first UE, a transmission on a transmission serving beam based on the PSFCH used to receive ACK or NACK.

Other aspects includes apparatuses, systems, and computer programs for performing the actions of the aforementioned method.

The innovative method can include other optional features. For example, in some implementations, transmitting, by a first UE, a unicast packet to a second UE using a preconfigured set of transmission serving beams, receiving, by the first UE, at least one ACK or NACK from the second UE in a physical sidelink feedback channel (PSFCH), and transmitting, by the first UE, a transmission using a transmission serving beam determined based on the PSFCH used to receive ACK or NACK.

In some implementations, receiving, by the first UE, at least one ACK or NACK from the second UE in PSFCH can include receiving, by the first UE, an ACK or NACK from the second UE in PSFCH corresponding to each beam.

In some implementations, transmission serving beam used, by the first UE, to transmit the transmission is determined by performing operations that include evaluating, by the first UE, each of the multiple transmission serving beams used by the RX UE to transmit an ACK or ACK, and selecting, by the first UE, a transmission serving beam of the multiple transmission serving beams used by the second UE to transmit ACK or NACK for subsequent transmission to the second UE having the highest SL RSRP, wherein the selected transmission beam is the transmission serving beam used to transmit the transmission.

In some implementations, receiving, by the first UE, at least one ACK or NACK from the second UE in PSFCH can include receiving, by the first UE, ACK or NACK from the second UE only in PSFCH corresponding to the transmission serving beam of the set of transmission serving beams having the highest SL RSRP.

In some implementations, the transmission serving beam used, by the first UE, to transmit the transmission is determined by performing operations that comprise: selecting, by the first UE, the only transmission serving beam used by the second UE to transmit ACK or NACK for subsequent unicast transmission to the second UE, wherein the selected transmission beam is the transmission serving beam used to transmit the transmission.

In some implementations, transmitting, by the first UE, a transmission using a transmission serving beam determined based on the PSFCH used to receive ACK or NACK can include transmitting, by the first UE, a subsequent unicast transmission to the second UE using a transmission serving beam determined based on the PSFCH used to receive ACK or NACK.

According to another innovative aspect of the present disclosure, a method for beam recovery is disclosed. In one aspect, the method can include transmitting, by a first UE, a unicast packet to a second UE using a preconfigured set of transmission serving beams, receiving, by the first UE, at least one ACK or NACK from the second UE in PSFCH, and determining, by the first UE, a transmission serving beam based on the PSFCH used to receive ACK or NACK.

Other aspects includes apparatuses, systems, and computer programs for performing the actions of the aforementioned method.

The innovative method can include other optional features. For example, in some implementations, receiving, by the first UE, at least one ACK or NACK from the second UE in PSFCH can include receiving, by the first UE, an ACK or NACK from the second UE in PSFCH corresponding to each beam.

In some implementations, determining, by the first UE, a transmission serving beam based on the PSFCH used to receive ACK or NACK can include evaluating, by the first UE, each of the multiple transmission serving beams used by the RX UE to transmit an ACK or ACK, and selecting, by the first UE, the best transmission serving beam of the multiple transmission serving beams used by the second UE to transmit ACK or NACK for subsequent unicast packet transmission to the second UE.

In some implementations, receiving, by the first UE, at least one ACK or NACK from the second UE in PSFCH can include receiving, by the first UE, ACK or NACK from the second UE only in PSFCH corresponding to the transmission serving beam with the best SL RSRP.

In some implementations, determining, by the first UE, a transmission serving beam based on the PSFCH used to receive ACK or NACK can include selecting, by the first UE, the only transmission serving beam used by the second UE to transmit ACK or NACK for subsequent unicast transmission to the second UE determining, by the first UE, a transmission serving beam based on the PSFCH used to receive ACK or NACK.

According to another innovative aspect of the present disclosure, a method for establishing a communication link is disclosed. In one aspect the method can include receiving, by a first UE, a direct communication request transmitted by a second UE using a preconfigured set of transmission serving beams, selecting, by the first UE, a particular transmission serving beam from a set of transmission serving beams for use in transmitting a direct security mode message to the second UE, and transmitting, by the first UE, the direct security mode message to the second UE using a resource associated with the selected transmission serving beam.

Other aspects includes apparatuses, systems, and computer programs for performing the actions of the aforementioned method.

The innovative method can include other optional features. For example, in some implementations, the method can further include receiving, by the first UE, a transmission on a transmission serving beam from the second UE that was determined based on the resource used, by the first UE, to transmit the direct security mode message.

In some implementations, selecting, by the first UE, a particular transmission serving beam from a set of transmission serving beams for use in transmitting a direct security mode message to the second UE can include selecting, by the first UE, a particular transmission serving beam from the set of transmission serving beams for use in transmitting the direct security mode message based on a sidelink reference signal received power (RSRP) associated with each of the transmission serving beams.

In some implementations, selecting, by the first UE, a particular transmission serving beam from a set of transmission serving beams for use in transmitting a direct security mode message to the second UE can include selecting, by the first UE, a particular transmission serving beam from the set of transmission serving beams for use in transmitting the direct security mode message based on the particular transmission serving beam having the best sidelink reference signal received power (RSRP).

In some implementations, the particular transmission serving beam having the best SL RSRP is the particular transmission serving beam of the set of transmission serving beams having the highest SL RSRP.

According to another innovative aspect of the present disclosure, a method for establishing a communication link is disclosed. In one aspect, the method can include receiving, by a first UE, a unicast packet that was transmitted by a second UE using a preconfigured set of transmission serving beams, determining, by the first UE, one or more transmission serving beams for transmitting an ACK or NACK to the second UE, and transmitting, by the first UE, at least one ACK or NACK to the second UE in PSFCH.

Other aspects includes apparatuses, systems, and computer programs for performing the actions of the aforementioned method.

The innovative method can include other optional features. For example, in some implementations, the method can further include receiving, by the first UE, a subsequent transmission from the second UE using a transmission beam determined based on the PSFCH used by the second UE to receive the ACK or NACK transmitted by the first UE.

In some implementations, transmitting, by the UE, at least one ACK or NACK to the second UE in PSFCH can include transmitting, by the first UE, an ACK or NACK to the second UE in PSFCH corresponding to each beam of the preconfigured set of transmission serving beams.

In some implementations, transmitting, by the UE, at least one ACK or NACK to the second UE in PSFCH can include transmitting, by the first UE, an ACK or NACK to the second UE only in PSFCH corresponding to a transmission serving beam of the of the set of transmission serving beams having the highest SL RSRP.

According to another innovative aspect of the present disclosure, a method for beam recovery is disclosed. In one aspect, the method can include receiving, by a first UE, a unicast packet that was transmitted by a second UE using a preconfigured set of transmission serving beams, determining, by the first UE, one or more transmission serving beams for transmitting an ACK or NACK to the second UE, and transmitting, by the first UE, at least one ACK or NACK to the second UE in PSFCH, wherein the second UE is configured to determine a transmission serving beam based on the PSFCH used by the second UE to receive the ACK or NACK transmitted by the first UE.

Other aspects includes apparatuses, systems, and computer programs for performing the actions of the aforementioned method.

The innovative method can include other optional features. For example, in some implementations, determining, by the first UE, one or more transmission serving beams for transmitting an ACK or NACK to the second UE can include transmitting, by the first UE, an ACK or NACK to the second UE in PSFCH corresponding to each beam of the preconfigured set of transmission serving beams.

In some implementations, determining, by the first UE, one or more transmission serving beams for transmitting an ACK or NACK to the second UE can include transmitting, by the first UE, an ACK or NACK to the second UE only in PSFCH corresponding to a transmission serving beam of the preconfigured set of transmission serving beams with the best SL RSRP.

According to another innovative aspect of the present disclosure, a method for beam failure detection (BFD) is disclosed. In one aspect, the method can include triggering, by a first UE, a beam failure detection procedure based on a determination that a NACK or no feedback is received from a second UE responsive to a transmission of a packet from the first UE to the second UE using a transmission serving beam serving the second UE, re-transmitting, by the first UE, the packet to the second UE using the transmission serving beam, maintaining, by the first UE, a beam failure instance counter, wherein the beam failure instance counter provides an indication as to a number of occurrences of a NACK or no feedback is received from the second UE, and determining, by the first UE, whether a beam failure has been detected based on the beam failure instance counter.

Other aspects includes apparatuses, systems, and computer programs for performing the actions of the aforementioned method.

The innovative method can include other optional features. For example, in some implementations, maintaining, by the first UE, the beam failure instance counter can include determining, by the first UE, that a NACK has been received after re-transmission of the packet, and based on a determination, by the first UE, that the NACK has been received after re-transmission of the packet, increasing the beam failure instance counter by one.

In some implementations, after re-transmitting, by the first UE, the packet to the second UE using the transmission serving beam serving the second UE, starting a beam failure detection timer.

In some implementations, maintaining, by the first UE, the beam failure instance counter can include determining, by the first UE, that the beam failure detection timer has expired without receipt of an ACK or NACK after re-transmission of the packet, and based on a determination, by the first UE, that the beam failure detection timer has expired without receipt of the ACK or NACK after re-transmission of the packet, increasing the beam failure instance counter by one.

In some implementations, maintaining, by the first UE, the beam failure instance counter can include determining, by the first UE, that an ACK has been received after re-transmission of the packet, and based on a determination, by the first UE, that the ACK has been received after re-transmission of the packet, resetting the beam failure instance counter and stopping the beam failure detection timer.

In some implementations, maintaining, by the first UE, the beam failure instance counter can include determining, by the first UE, that an ACK has been received after re-transmission of the packet, and based on a determination, by the first UE, that the ACK has been received after re-transmission of the packet, resetting the beam failure instance counter.

In some implementations, re-transmitting, by a first UE, the packet to the second UE using the transmission serving beam can include re-transmitting the packet with a CSI trigger in SCI.

In some implementations, the method can further include receiving, by the first UE, a CSI report from the second UE via an access node, wherein the CSI report was transmitted, by the second UE, based on a determination, by the second UE, that a sidelink beam failure recovery MAC-CE was not received by the second UE from the first UE.

In some implementations, the method can further include re-transmitting, by the first UE, the packet using a different transmission serving beam selected by the first UE based on the received CSI report.

In some implementations, determining, by the first UE, whether a beam failure has been detected based on the beam failure instance counter can include determining, by the first UE, whether the beam failure instance counter exceeds a beam failure instance max count.

In some implementations, the method can further include based on a determination, by the first UE, that the beam failure instance counter exceeds a beam failure instance max count, determining, by the UE, that a beam failure has been detected.

In some implementations, the method can further include based on a determination, by the first UE, that a beam failure has been detected based on the beam failure instance counter: transmitting, by the first UE, a unicast packet to the second UE using a preconfigured set of transmission serving beams, receiving, by the first UE, at least one ACK or NACK from the second UE in PSFCH, and determining, by the first UE, a transmission serving beam based on the PSFCH used to receive ACK or NACK.

In some implementations, the method can further include based on a determination, by the first UE, that a beam failure has been detected based on the beam failure instance counter: determining, by the first UE, that a radio link failure (RLF) has been detected.

In some implementations, the method can further include based on a determination, by the first UE, that a beam failure has been detected based on the beam failure instance counter: transmitting, by the first UE, data to a gNB that (i) indicates that a radio link failure (RLF) with the second UE has been detected and (ii) requests reconfiguration of the set of transmission serving beams.

In some implementations, the method can further include based on a determination, by the first UE, that a beam failure has been detected based on the beam failure instance counter: transmitting, by the first UE, data to the second UE that (i) indicates that a radio link failure (RLF) with the second UE has been detected using another PC5 carrier.

In some implementations, the method can further include based on a determination, by the first UE, that a beam failure has been detected based on the beam failure instance counter: transmitting, by the first UE, a direct communication request to the second UE using a preconfigured set of transmission serving beams, receiving, by the first UE, a direct security mode message from the second UE, wherein the direct security mode message was transmitted, by the second UE, using a resource associated with a particular transmission serving beam of the set of transmission serving beams selected by the second UE, and determining, by the first UE, a transmission serving beam based on the resource associated with the particular transmission serving beam and used to receive the direct security mode message.

### BRIEF DESCRIPTION OF THE DRAWINGS

FIG. 1 is a flow diagram of an example of a process for sidelink (SL) beam failure detection (BFD), in accordance with one aspect of the present disclosure.

FIG. 2 is a flowchart of an example of a process for performing SL BFD as described with reference to FIG. 1, in accordance with one aspect of the present disclosure.

FIG. 3 is a flow diagram of an example of a process for performing SL BFD utilizing CSI triggering, in accordance with one aspect of the present disclosure.

FIG. 4 is a flowchart of an example of a process for performing SL BFD that includes use of CSI trigger as described with reference to FIG. 3, in accordance with one aspect of the present disclosure.

FIG. 5 is a flow diagram of an example of a process for performing SL beam sweeping, in accordance with one aspect of the present disclosure.

FIG. 6A is a flowchart of an example of a process 600A executed by a transmitting UE while performing SL beam sweeping as described with reference to FIG. 5, in accordance with one aspect of the present disclosure.

FIG. 6B is a flowchart of an example of a process 600B executed by a receiving UE while performing SL beam sweeping as described with reference to FIG. 5, in accordance with one aspect of the present disclosure.

FIG. 7 is a flow diagram of an example of another process for performing SL beam sweeping, in accordance with one aspect of the present disclosure.

FIG. 8A is a flowchart of an example of a process 800A executed by a transmitting UE while performing SL beam sweeping as described with reference to FIG. 7, in accordance with one aspect of the present disclosure.

FIG. 8B is a flowchart of an example of a process 800B executed by a receiving UE while performing SL beam sweeping as described with reference to FIG. 7, in accordance with one aspect of the present disclosure.

FIG. 9 is an example of a wireless communication system.

FIG. 10 is a block diagram of an example of user equipment (UE).

FIG. 11 is a block diagram of an example of an access node.

Like reference symbols in the various drawings indicate like elements.

### DETAILED DESCRIPTION

This disclosure describes methods and systems for sidelink beam failure detection and recovery. The methods and systems can be used in scenarios where a first UE (e.g., a TX UE or transmitting UEs) is communicating via sidelink with one or more second UEs (e.g., RX UEs or receiving UEs). The first and/or the second UEs may be served by a base station. In these methods and systems, a TX UE detects sidelink beam failure and responsively triggers beam failure recovery procedures.

Related methods in the field of sidelink beam failure detection and recovery have relied on the RX UE to detect and/or report beam failure. While such implementations have technological benefits, sidelink beam failure recovery information of the RX UE may not be sent to the TX UE if the communication link from the RX UE to the TX UE is also in failure. Accordingly, the present disclosure is directed towards providing a solution to the aforementioned problem that enables the TX UE to perform sidelink beam failure detection and trigger sideline beam failure recovery—even in instances where a communication link from the RX UE to the TX UE is in a state of failure.

### TX UE Sidelink Beam Failure Detection (SL BFD)

In some implementations, the present disclosure enables TX UE sidelink beam failure detection by maintaining a beam failure instance counter (BFI_COUNTER) or other similarly configured parameter. In order for the TX UE to use the beam failure instance counter (or other parameter) to detect sidelink beam failure, the TX UE can have a sidelink configuration that tracks a beamFailureInstanceMaxCount and a beamFailureDetectionTimer for each RX UE in sidelink communication with TX UE. The TX UE can be configured to track the aforementioned parameters via PC5 RRC signaling. Alternatively, the TX UE can be via pre-configured per resource pool or configured by gNB to track the aforementioned parameters.

The beam failure instance counter can be initialized to zero upon triggering of a beam failure detection procedure. In some implementations, the beam failure detection procedure can be triggered after a predetermined number of NACK or no feedback is received from a peer RX UE side. In some implementations, for example, the TX UE can be configured to trigger a beam failure detection procedure after only a single NACK or no feedback. In other implementations, however, the TX UE can be configured to trigger a sidelink beam failure detection procedure after a (pre)configured number of multiple NACKs or no feedbacks are received from peer RX UE 120. The beam failure instance counter is then configured to increment each time a NACK or no feedback is received from the peer RX UE side.

The beamFailureDetectionTimer and the beamFailureInstanceMaxCount can be used by a TX UE in conjunction with the beam failure instance counter to perform sidelink beam failure detection by the TX UE. The TX UE can use the beamFailureDetectionTimer to detect when no feedback is received from a peer RX UE. For example, TX UE can start the beamFailureDetectionTimer after making a transmission to the RX UE and, then, if the beamFailureDetectionTimer expires before receipt of an ACK or NACK from the RX UE, the TX UE can increase the beam failure instance by one upon the expiration of the beamFailureDetectionTimer. The beamFailureDetectionTimer thus enables the TX UE to maintain an accurate count of NACKs or no feedback from a RX UE by providing a method for objectively determining an occurrence of no feedback from an RX UE.

The TX UE can then use the beamFailureInstanceMaxCount to evaluate whether the beam failure instance counter has exceeded a predetermined number of NACKs or no feedback. Once the beam failure instance counter exceeds the beamFailureInstanceMacCount, the TX UE can determine that a sidelink beam failure has been detected.

The BFD procedure using these features is triggered by a TX UE when a preconfigured number of NACK or no feedback is received from peer RX UE side after transmitting a packet to the RX UE using a first serving beam. The TX UE can retransmit the packet with same serving beam to the RX UE. The TX UE starts/restarts the beamFailureDetectionTimer started/restarted upon completion of transmitting. If NACK is received, TX UE's MAC increases BFI_COUNTER by 1. Else if ACK is received, TX UE's MAC resets BFI_COUNTER and stops the beamFailureDetectionTimer. Else if no response is received and the beamFailureDetectionTimer expires, the TX UE's MAC regards it is a discontinuous transmission (DTX), and increases BFI_COUNTER by 1. The beamFailureDetectionTimer is stopped when ACK or NACK is received from RX UE. The TX UE can monitor the relation between the BFI_COUNTER and the beamFailureInstanceMaxCount. If BFI_COUNTER exceeds the beamFailureInstanceMaxCount, then the TX UE's MAC declares SL BFD.

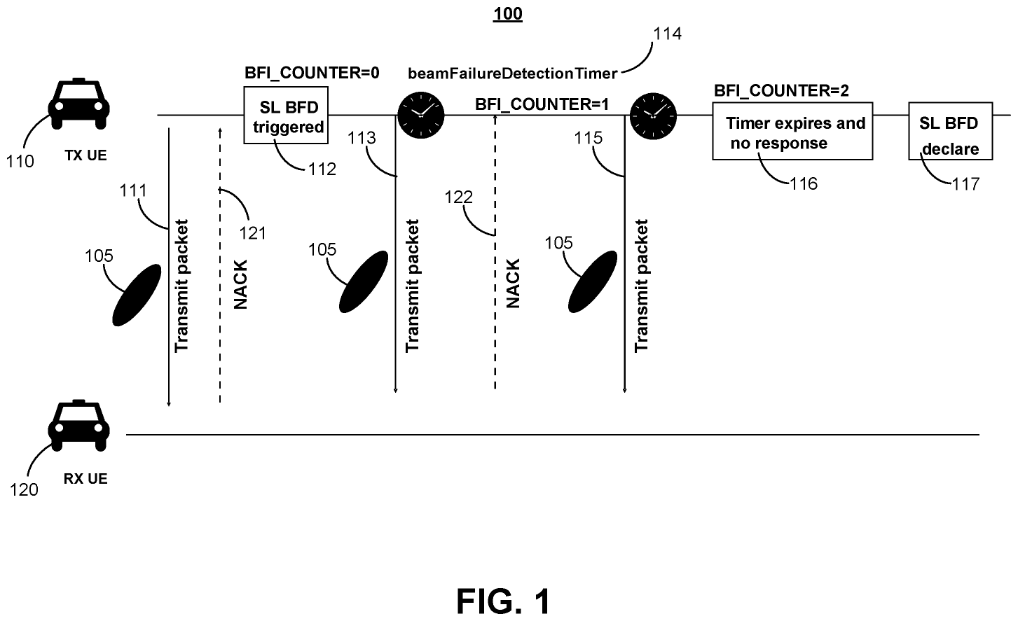

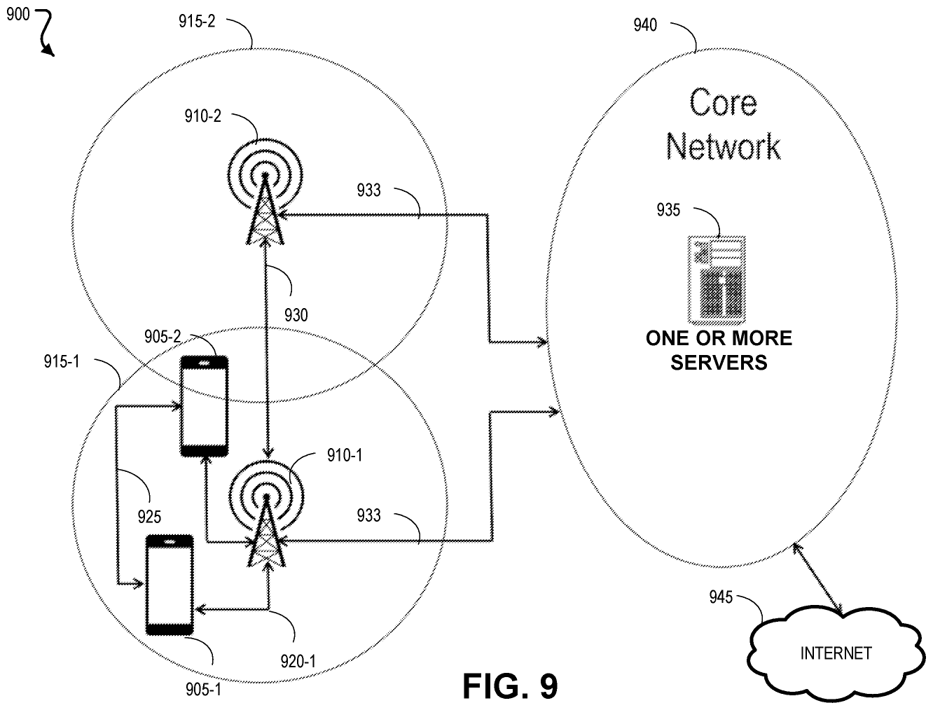

FIG. 1 is a flow diagram of an example of a process 100 for sidelink (SL) beam failure detection (BFD), in accordance with one aspect of the present disclosure. The TX UE 110 and the RX UE 120 can each be a UE such as UE 905 of the communication system 900 of FIG. 9.

The process 100 can begin with the TX UE 110 transmitting 111 a packet to a RX UE 120 using a first transmission serving beam 105. After transmission of the packet at 111, the TX UE 110 starts the beamFailureDetectionTimer. Upon receipt 121 of the NACK, the TX UE 110 triggers 112 a sidelink beam failure detection procedure.

The TX UE 110 then retransmits 113 the packet to the RX UE 120 using the same serving beam 105. The TX UE 110 starts or restarts the beamFailureDetectionTimer 114 upon completion of the transmitting at 113. The TX UE 110 receives 122 a NACK, stops the beamFailureDetectionTimer 114, and the TX UE's MAC increases BFI_COUNTER by 1. The TX UE 110 then retransmits 115 the packet to RX UE 120 using the same serving beam 105. After the transmission of the packet at 115, the TX UE 110 starts or restarts the beamFailureDetectionTimer 114 upon completion of the transmitting at 115. In the process flow 100, the beamFailureDetectionTimer 114 expires 116 without the TX UE 110 receiving a response from the RX UE 120. The TX UE 110 increases the BFI_COUNTER by 1 to 2. In this example, at stage 116, the TX UE can determine that the BFI_COUNTER=2>beamFailureInstanceMaxCount,=1. Based on the determination that the BFI_COUNTER has exceeded the beamFailureInstanceMaxCount, the TX UE's MAC can declare SL BFD at 117. Declaring SL BFD can include, for example, declaring SL BFD by UE's MAC, which then triggers BF recovery.

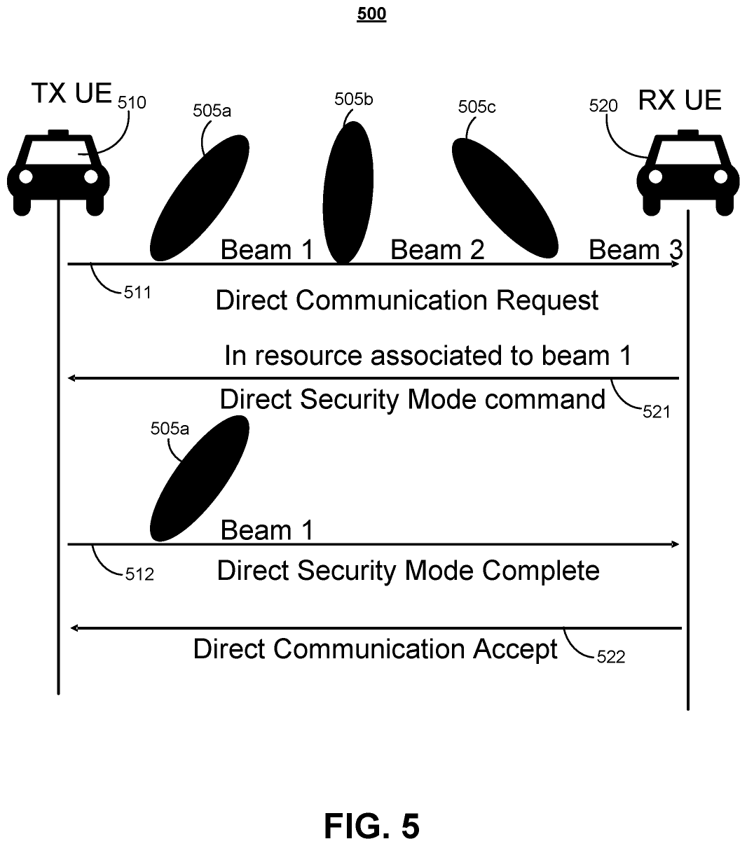

Upon detection of the SL BFD, the TX UE can initiate one or more beam failure recovery (BFR) procedures. These can include, for example, the beam sweeping procedures described with respect to FIGS. 5, 6A, 6B, 7, 8A, and 8B and their corresponding written description. Alternatively, or in addition, the TX UE can perform one or more other BFR procedures such as, for example, the TX UE declaring SL RLF directly, the TX UE reporting failure information to gNB for its reconfiguration, or the TX UE reporting the failure information to RX UE via another PC5 carrier. The TX UE declaring SL RLF means that the TX UE has determined that the current link cannot be recovered—i.e., that BF recovery is not useful.

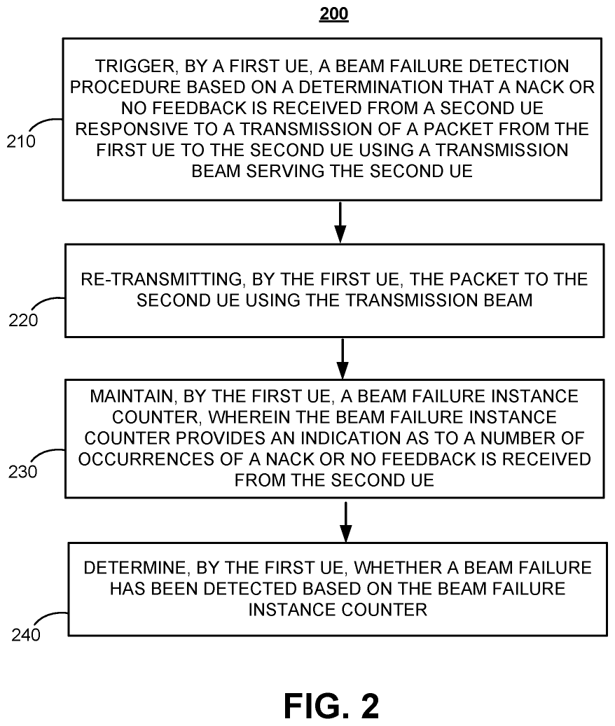

FIG. 2 is a flowchart of an example of a process 200 for performing SL BFD as described with reference to FIG. 1, in accordance with one aspect of the present disclosure. The process 200 will be described as being perform by a first UE (e.g., TX UE), which can be a device such as a UE 905 of FIG. 9.

A first UE (e.g., TX UE) can begin performance of the process 200 by triggering a beam failure detection procedure based on a determination that a NACK or no feedback is received from a second UE (e.g., RX UE) responsive to a transmission of a packet from the first UE to the second UE using a transmission serving beam serving the second UE (210).

The first UE can continue execution of the process 200 by re-transmitting the packet to the second UE using the transmission serving beam (220).

The first UE can continue execution of the process 200 by maintaining a beam failure instance counter, wherein the beam failure instance counter provides an indication as to a number of occurrences of a NACK or no feedback is received from the second UE (230). In some implementations, the first UE can maintain the beam failure instance counter by determining that a NACK has been received after re-transmission of the packet, and based on a determination, by the first UE, that the NACK has been received after re-transmission of the packet, the first UE can increase the beam failure instance counter by one.

In some implementations, the first UE can maintain the beam failure instance counter can include determining that an ACK has been received after re-transmission of the packet, and based on a determination that the ACK has been received after re-transmission of the packet, the first UE can reset the beam failure instance counter.

The first UE can continue execution of the process 200 by determining whether a beam failure has been detected based on the beam failure instance counter (240). In some implementations, execution of stage 240 by the first UE can include the first UE determining whether the beam failure instance counter exceeds a beam failure instance max count. In some implementations, based on a determination, by the first UE, that the beam failure instance counter exceeds a beam failure instance max count, the first UE can further determine that a beam failure has been detected.

In some implementations, after the first UE re-transmits the packet to the second UE using the transmission serving beam serving the second UE, the first UE's execution of the process 200 further includes starting a beam failure detection timer.

For implementation using a beam failure detection timer, the first UE can maintain the beam failure instance counter by determining that the beam failure detection timer has expired without receipt of an ACK or NACK after re-transmission of the packet, and based on a determination that the beam failure detection timer has expired without receipt of the ACK or NACK after re-transmission of the packet, the first UE can increase the beam failure instance counter by one.

Alternative, or in addition, for implementations using a beam failure detection timer, the first UE can maintain the beam failure instance counter by determining that an ACK has been received after re-transmission of the packet, and based on a determination that the ACK has been received after re-transmission of the packet, the first UE can reset the beam failure instance counter and stop the beam failure detection timer.

Upon detection of the SL BFD using the process 200, the TX UE can initiate one or more beam failure recovery (BFR) procedures. These can include, for example, the beam sweeping procedures described with respect to FIGS. 5, 6A, 6B, 7, 8A, and 8B and their corresponding written description. Alternatively, or in addition, the TX UE can perform one or more other BFR procedures such as, for example, the TX UE declaring SL RLF directly, the TX UE reporting failure information to gNB for its reconfiguration, or the TX UE reporting the failure information to RX UE via another PC5 carrier.

### TX UE Sidelink Beam Failure Detection (SL BFD) with CSI Triggering

In some implementations, the SL BFD procedure of the present disclosure can use CSI triggering in SCI and then a TX UE can then adjust its transmission serving beam based on CSI reporting received from the RX UE.

The BFD procedure with CSI triggering is triggered by a TX UE when a preconfigured number of NACK or no feedback is received from peer RX UE side after transmitting a packet to the RX UE using a first serving beam. The TX UE can retransmit the packet with same serving beam to the RX UE with CSI triggering in SCI. Use of the CSI triggering enables the TX UE to adjust the transmit beam based on subsequent CSI reporting from RX UE. The TX UE starts/restarts the beamFailureDetectionTimer started/restarted upon completion of transmitting. If NACK is received, TX UE's MAC increases BFI_COUNTER by 1. Else if ACK is received, TX UE's MAC resets BFI_COUNTER and stops the beamFailureDetectionTimer. Else if no response is received and the beamFailureDetectionTimer expires, the TX UE's MAC regards it is a DTX, and increases BFI_COUNTER by 1. The beamFailureDetectionTimer is stopped when ACK or NACK is received from RX UE. The RX UE can report CSI to the TX UE via gNB forwarding if ACK for SL beam failure recovery (BFR) MAC-CE is not received from TX UE. The TX UE can monitor the relation between the BFI_COUNTER and the beamFailureInstanceMaxCount. If BFI_COUNTER exceeds the beamFailureInstanceMaxCount, then the TX UE's MAC declares SL BFD.

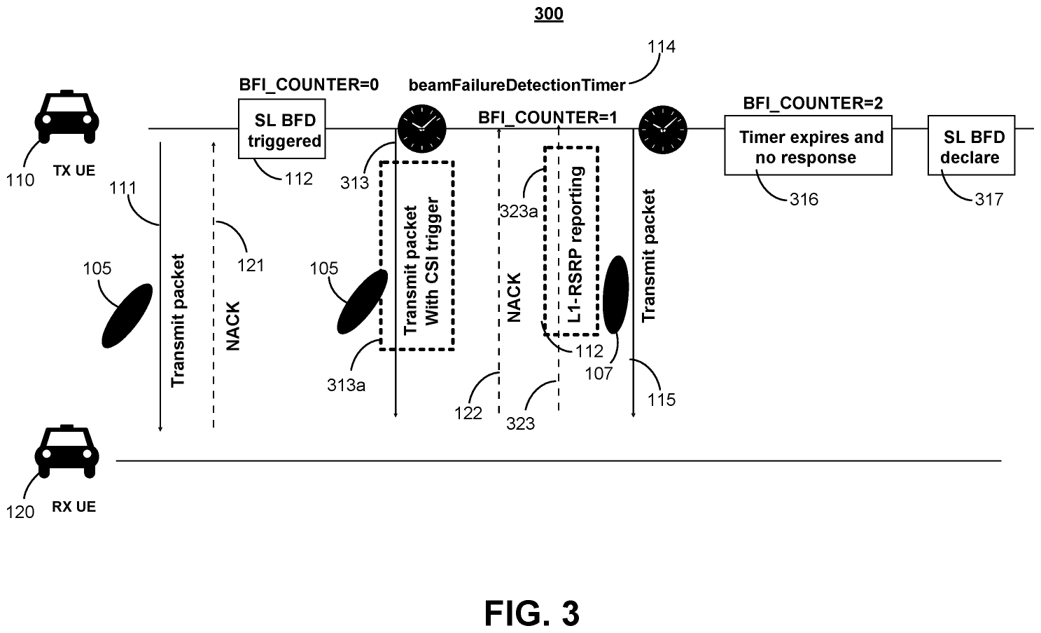

FIG. 3 is a flow diagram of an example of a process 300 for performing SL BFD utilizing CSI triggering, in accordance with one aspect of the present disclosure. The TX UE 110 and the RX UE 120 can each be a UE such as UE 905 of the communication system 900 of FIG. 9.

The process 300 can begin with the TX UE 110 transmitting 111 a packet to a RX UE 120 using a first transmission serving beam 105. Upon receipt 121 of the NACK, the TX UE 110 triggers 112 a sidelink beam failure detection procedure.

The TX UE 110 then transmits 313 the packet 313a to the RX UE 120 with a CSI trigger using the same serving beam 105. Responsive to the CSI Trigger in the received packet 313a, the RX UE 120 causes CSI report 323a to be reported 323 to the TX UE 110 via gNodeB. The CSI report 323a can include beam failure indication data such as L1-RSRP reporting that reports information related to beam failure instance indications. A beam failure instance indication may be generated when the radio link quality belonging to monitored reference signals is worse than a predetermined threshold. In this example, the L1-RSRP reporting can provide an indication as to the level of sidelink reference signal received power (SL RSRP) of each the transmission serving beam used for transmission 313a, a SL RSRP of one or more other transmission serving beams, or a combination thereof.

The TX UE 110 then select a different transmission serving beam 107 based on the CSI reporting 323a received via transmission 323 and then transmits 115 the packet using the different selected transmission serving beam 107. The TX UE 110 starts or restarts the beamFailureDetectionTimer 114 upon completion of the transmitting at 115.

In the process flow 300, the beamFailureDetectionTimer 114 expires 316 without the TX UE 110 receiving a response from the RX UE 120. The TX UE 110 increases the BFI_COUNTER by 1 to 2. In this example, at stage 316, the TX UE can determine that the BFI_COUNTER=2>beamFailureInstanceMaxCount,=1. Based on the determination that the BFI_COUNTER has exceeded the beamFailureInstanceMaxCount, the TX UE's MAC can declare SL BFD at 317.

Upon detection of the SL BFD, the TX UE can initiate one or more beam failure recovery (BFR) procedures. These can include, for example, the beam sweeping procedures described with respect to FIGS. 5, 6A, 6B, 7, 8A, and 8B and their corresponding written description. Alternatively, or in addition, the TX UE can perform one or more other BFR procedures such as, for example, the TX UE declaring SL RLF directly, the TX UE reporting failure information to gNB for its reconfiguration, or the TX UE reporting the failure information to RX UE via another PC5 carrier.

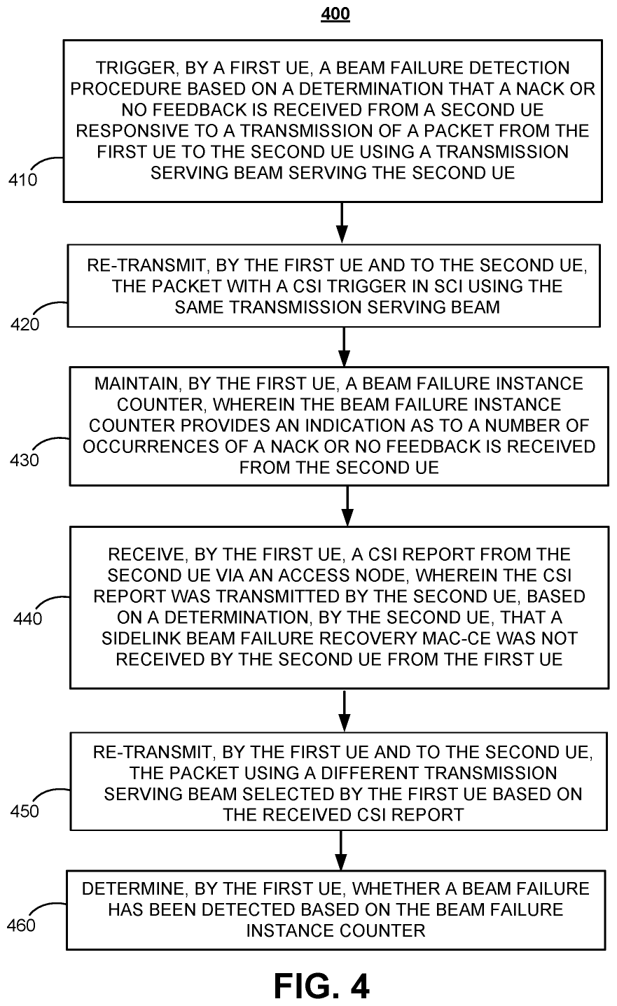

FIG. 4 is a flowchart of an example of a process 400 for performing SL BFD that includes use of CSI trigger as described with reference to FIG. 3, in accordance with one aspect of the present disclosure. The process 400 will be described as being perform by a first UE (e.g., TX UE), which can be a device such as a UE 905 of FIG. 9.

A first UE (e.g., TX UE) can begin performance of the process 400 by triggering a beam failure detection procedure based on a determination that a NACK or no feedback is received from a second UE (e.g., RX UE) responsive to a transmission of a packet from the first UE to the second UE using a transmission serving beam serving the second UE (410).

The first UE can continue execution of the process 400 by re-transmitting the packet with a CSI trigger in SCI to the second UE using the transmission serving beam (420).

The first UE can continue execution of the process 400 by maintaining a beam failure instance counter, wherein the beam failure instance counter provides an indication as to a number of occurrences of a NACK or no feedback is received from the second UE (430). In some implementations, the first UE can maintain the beam failure instance counter by determining that a NACK has been received after re-transmission of the packet, and based on a determination, by the first UE, that the NACK has been received after re-transmission of the packet, the first UE can increase the beam failure instance counter by one.

In some implementations, the first UE can maintain the beam failure instance counter can include determining that an ACK has been received after re-transmission of the packet, and based on a determination that the ACK has been received after re-transmission of the packet, the first UE can reset the beam failure instance counter.

The first UE can continue execution of the process 400 by receiving a CSI report from the second UE via an access node, wherein the CSI report was transmitted, by the second UE, based on a determination, by the second UE, that a sidelink beam failure recovery MAC-CE was not received by the second UE from the first UE (440).

The first UE can continue execution of the process 400 by retransmitting the packet using a different transmission serving beam selected by the first UE based on the received CSI report (450).

The first UE can continue execution of the process 400 by determining whether a beam failure has been detected based on the beam failure instance counter (460). In some implementations, execution of stage 460 by the first UE can include the first UE determining whether the beam failure instance counter exceeds a beam failure instance max count. In some implementations, based on a determination, by the first UE, that the beam failure instance counter exceeds a beam failure instance max count, the first UE can further determine that a beam failure has been detected.

In some implementations, after the first UE re-transmits the packet to the second UE using the transmission serving beam serving the second UE or a different transmission serving beam selected by the first UE based on the CSI report from the second UE, the first UE's execution of the process 400 further includes starting a beam failure detection timer.

For implementations using the beam failure detection timer, the first UE can maintain the beam failure instance counter by determining that the beam failure detection timer has expired without receipt of an ACK or NACK after re-transmission of the packet, and based on a determination that the beam failure detection timer has expired without receipt of the ACK or NACK after re-transmission of the packet, the first UE can increase the beam failure instance counter by one.

Alternative, or in addition, for implementations using the beam failure detection timer, the first UE can maintain the beam failure instance counter by determining that an ACK has been received after re-transmission of the packet, and based on a determination that the ACK has been received after re-transmission of the packet, the first UE can reset the beam failure instance counter and stop a beam failure detection timer.

Upon detection of the SL BFD using the process 400, the TX UE can initiate one or more beam failure recovery (BFR) procedures. These can include, for example, the beam sweeping procedures described with respect to FIGS. 5, 6A, 6B, 7, 8A, and 8B and their corresponding written description. Alternatively, or in addition, the TX UE can perform one or more other BFR procedures such as, for example, the TX UE declaring SL RLF directly, the TX UE reporting failure information to gNB for its reconfiguration, or the TX UE reporting the failure information to RX UE via another PC5 carrier.

### SL Beam Sweeping

SL Beam Sweeping includes procedures that can be used by a TX UE to select a different transmission serving beam for used in making transmissions to an RX UE. One or more of these SL Beam Sweeping procedures may be employed by the TX UE to facilitate SL BFR.

### PC5-S Based Beam Recovery

In some implementations, a PC5-S based solution for initial PC5 link establishment can be used to facilitate beam recovery. Such an implementations is described with reference to FIG. 5.

FIG. 5 is a flow diagram of an example of a process 500 for performing SL beam sweeping, in accordance with one aspect of the present disclosure. The TX UE 510 and the RX UE 520 can each be a UE such as UE 905 of the communication system 900 of FIG. 9.

The TX UE 510 can begin the process 500 by transmitting 511 a direct communication request (DCR) with a set of pre-configured set of TX serving beams 505a, 505b, 505c to RX UE 520. In some implementations, there is a pre-configured association between each of the preconfigured set of TX serving beams 505a, 505b, 505c and a resource used to receive a direct communication accept (DCA). The pre-configured association between each TX serving beam and a corresponding resource can be known by both UEs (e.g., via handshake or other configuration protocols).

The RX UE receives the DCR communicated by the set of TX serving beams 505a, 505b, 505c. The RX UE 520 can determine, detect, observe, etc. one or more quality of service parameters associated with the TX serving beams carrying the DCR. The RX UE 520 selects the TX serving beam with best SL RSRP and transmits 521 a Direct Security Mode (DSA) message using the resource associated with the best TX serving beam.

For example, the RX UE 520 can determine or observe one or more quality of service parameters for the resources used for receiving the DCR message, each resource associated with a corresponding TX serving beam. RX UE sends a DSA message to the TX UE using the resource associated with the best TX serving beam.

Then, based on the resource to used to receive the DSA message transmitted in stage 521, TX UE can determine the best TX serving beam. The TX UE can rely on the pre-configured association between the resource and the TX serving beams to determine the best TX serving beam.

The RX UE can determine the best SL RSRP by observing quality of service parameters for the reception of the DCR. The best TX serving beam can include, for example, the TX serving beam having one or more quality of service parameters that satisfy a predetermined threshold. For example, the best TX serving beam may be a TX serving beam having a SL RSRP that satisfies a predetermined threshold level of power. In other implementations, the best TX serving beam may be the TX serving beam having a highest relative quality of service parameter relative to other TX serving beams in a set of TX serving beams. For example, the best TX serving beam can be the TX serving beam having the highest SL RSRP amongst each of the TX serving beams in a set of TX serving beams. The TX UE 510 then transmits 512 a Direct Security Mode Complete (DSCA) message to the RX UE 520 using the determined best TX serving beam. After receipt of the DSCA, the RX UE 520 can transmit a DCA to the TX UE 510.

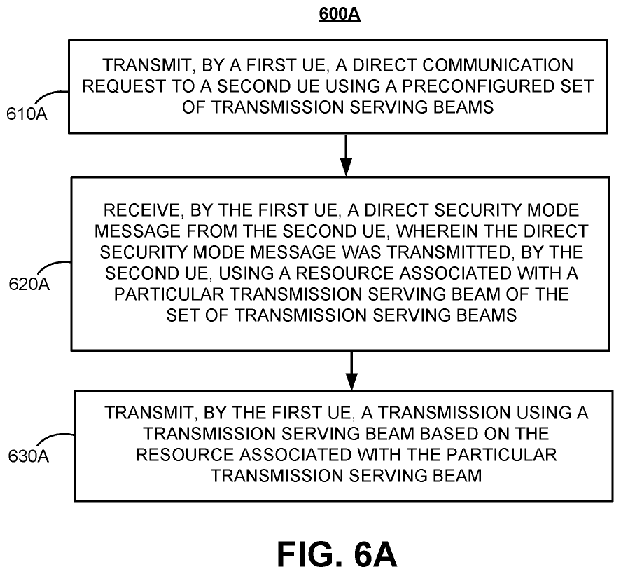

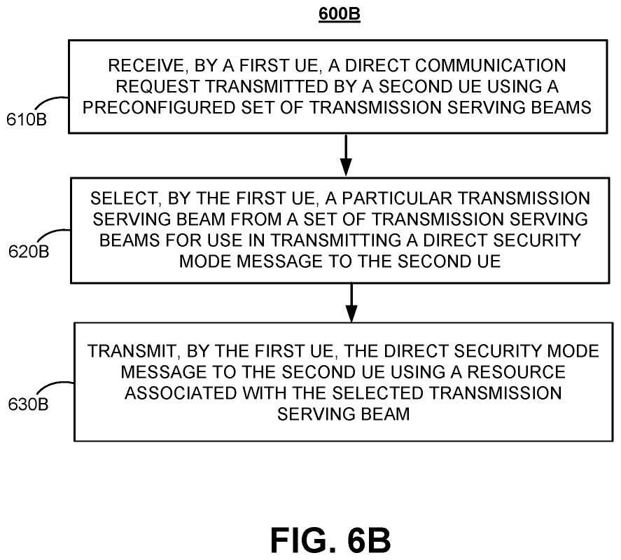

FIG. 6A is a flowchart of an example of a process 600A executed by a transmitting UE while performing SL beam sweeping as described with reference to FIG. 5, in accordance with one aspect of the present disclosure. The process 600A will be described as being perform by a first UE (e.g., TX UE), which can be a device such as a UE 905 of FIG. 9.

In this example, a first UE (e.g., TX UE) can begin the process 600A by transmitting a direct communication request to a second UE using a preconfigured set of transmission serving beams (610A). Here, preconfiguring means that the serving beam is configured before TX UE transmits a request to the second UE.

The first UE can continue execution of the process 600A by receiving a direct security mode message from the second UE, wherein the direct security mode message was transmitted, by the second UE, using a resource associated with a particular transmission serving beam of the set of transmission serving beams (620A). In some implementations, the particular transmission serving beam of the set of transmission serving beams selected by the second UE is selected based on a sidelink reference signal received power (RSRP) associated with each of the transmission serving beams. In some implementations, wherein the particular transmission serving beam of the set of transmission serving beams selected by the second UE is selected based on the particular transmission serving beam having the best sidelink reference signal received power (RSRP). In some implementations, a particular transmission serving beam has the best SL RSRP if the SL RSRP for the particular beam is the highest SL RSRP of each beam in the set of beams.

The first UE can continue execution of the process 600A by transmitting a transmission using a transmission serving beam based on the resource associated with the particular transmission serving beam (630A).

In some implementations, an association between the preconfigured set of transmission serving beams and a resource used, by the first UE, to receive direct communication acceptance is pre-configured.

In some implementations, the resource associated with the particular transmission serving beam of the set of transmission serving beams is selected by the second UE.

FIG. 6B is a flowchart of an example of a process 600B executed by a receiving UE while performing SL beam sweeping as described with reference to FIG. 5, in accordance with one aspect of the present disclosure. The process 600B will be described as being perform by a first UE (e.g., RX UE), which can be a device such as a UE 905 of FIG. 9.

In this example, a first UE (e.g., RX UE) can begin the process 600B by receiving direct communication request transmitted by a second UE using a preconfigured set of transmission serving beams (610B).

The first UE can continue execution of the process 600B by selecting a particular transmission serving beam from a set of transmission serving beams for use in transmitting a direct security mode message to the second UE (620B). In some implementations, the first UE's selection at stage 620B can include selecting a particular transmission serving beam from the set of transmission serving beams for use in transmitting the direct security mode message based on a sidelink reference signal received power (RSRP) associated with each of the transmission serving beams. In some implementations, the first UE's selection at stage 620B can include selecting a particular transmission serving beam from the set of transmission serving beams for use in transmitting the direct security mode message based on the particular transmission serving beam having the best sidelink reference signal received power (RSRP).

The first UE can continue execution of the process 600B by transmitting the direct security mode message to the second UE using a resource associated with the selected transmission serving beam.

In some implementations, the first UE can continue execution of the process 600B by receiving a transmission on a transmission serving beam from the second UE that was determined based on the resource used, by the first UE, to transmit the direct security mode message.

In some implementations, an association between the preconfigured set of transmission serving beams and a resource used, by the second UE, to receive direct communication acceptance is pre-configured.

### ACK/NACK Based SL Beam Recovery

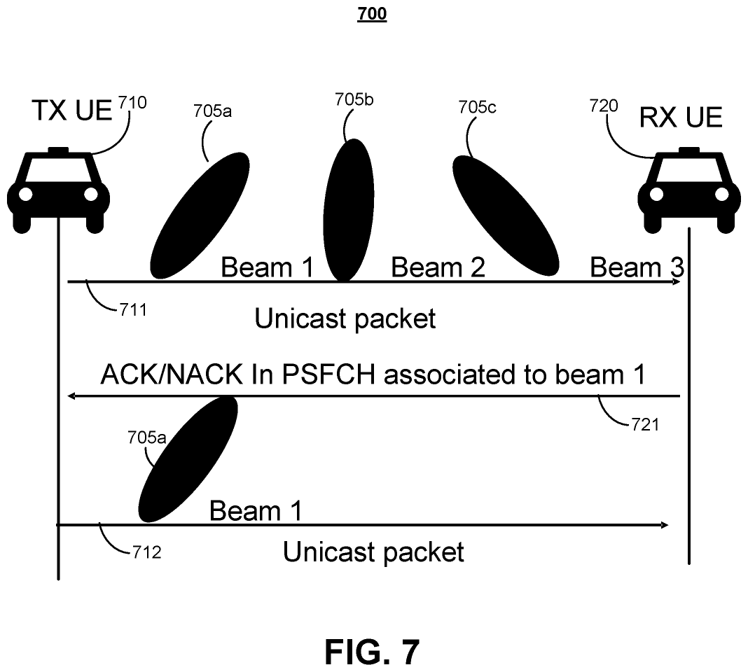

In some implementations, an ACK/NACK based solution for beam recovery can be employed by a TX UE. Such an implementations is described with reference to FIG. 7.

FIG. 7 is a flow diagram of an example of another process 700 for performing SL beam sweeping, in accordance with one aspect of the present disclosure. The TX UE 710 and the RX UE 720 can each be a UE such as UE 905 of the communication system 900 of FIG. 9.

The TX UE 710 can begin the process 700 by transmitting 711 a unicast packet, which is associated with a separate Physical Sidelink Feedback Channel (PSFCH) resource, to the RX UE 720 using a pre-configured set of TX serving beams 705a, 705b, 705c.

In some implementations, such as the example process 700 of FIG. 7, the RX UE 720 can transmit 721 ACK/NACK in the physical sidelink feedback channel (PSFCH) corresponding to only the TX serving beam, of the set of transmission serving beams 705a, 705b, 705c, having the best SL RSRP. Alternatively, in other implementations, the RX UE 720 can transmit at stage 721 an ACK/NACK in PSFCH corresponding to each beam of the set of TX serving beams 705a, 705b, 705c.

The TX UE can receive the transmission 721 from the RX UE and select a transmission serving beam for (re)transmitting 712 the unicast packet based on the ACK/NACK received in PSFCH from the RX UE 720. In some implementation of process 700 of FIG. 1, the TX UE can select TX serving beam 1 because the RX UE 720 only transmitted ACK/NACK in PSFCH having the best SL RSRP. However, in other implementations where the RX UE 720 transmits an ACK/NACK in PSFCH corresponding to each beam of the set of TX serving beams 705a, 705b, 705c, the TX UE 710 can determine a TX serving beam 705a, 705b, 705c for subsequent (re)transmission of a uncast packet to the RX UE 720 based on the PSFCH used to receive ACK/NACK. For example, the TX UE 710 can select the TX serving beam of the set of TX serving beams used to send each of the ACK/NACKs having the best SL RSRP.

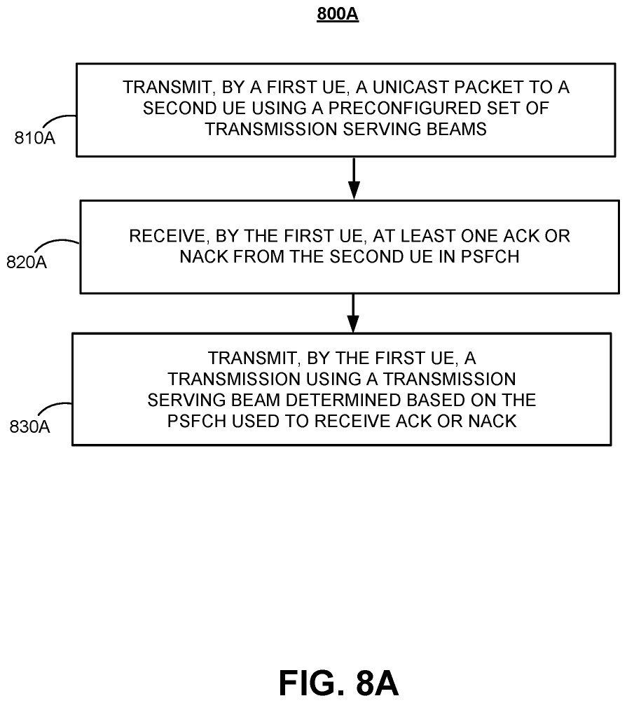

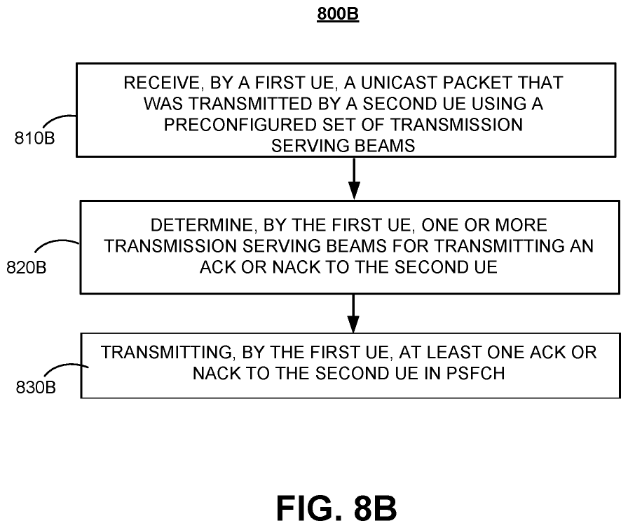

FIG. 8A is a flowchart of an example of a process 800A executed by a transmitting UE while performing SL beam sweeping as described with reference to FIG. 7, in accordance with one aspect of the present disclosure. The process 800A will be described as being perform by a first UE (e.g., TX UE), which can be a device such as a UE 905 of FIG. 9.

In this example, a first UE (e.g., TX UE) can begin execution of the process 800A by transmitting a unicast packet to a second UE (e.g., RX UE) using a preconfigured set of transmission serving beams (810A).

The first UE can continue execution of the process 800A by receiving at least one ACK or NACK from the second UE in PSFCH (820A). In some implementations, the first UE's receiving at stage 820A can include receiving an ACK or NACK from the second UE in PSFCH corresponding to each beam. In other implementations, the first UE's receiving at stage 820A can include receiving, by the first UE, ACK or NACK from the second UE only in PSFCH corresponding to beam having the highest SL RSRP.

The first UE can continue execution of the process 800A by transmitting a transmission using a transmission serving beam determined based on the PSFCH used to receive ACK or NACK (830A). In some implementations, the transmission serving beam used, by the first UE, to transmit the transmission is determined by first UE performing operations that include the first UE selecting the only transmission serving beam used by the second UE to transmit ACK or NACK. In other implementations, the transmission serving beam used, by the first UE, to transmit the transmission is determined by first UE performing operations that include the first UE evaluating each of the multiple transmission serving beams used by the RX UE to transmit an ACK or ACK and then selecting the best transmission serving beam of the multiple transmission serving beams for subsequent unicast packet transmission to the second UE. In some implementations, the best transmission serving beam of the multiple transmission serving beams is the transmission serving beam having the highest SL RSRP of the multiple transmission serving beams. The selected transmission beam selected using either of these methods is the transmission serving beam used to transmit the transmission at stage 830A.

In some implementations, the transmitting at stage 830A can include the first UE transmitting a subsequent unicast transmission to the second UE using a transmission serving beam determined based on the PSFCH used to receive ACK or NACK.

FIG. 8B is a flowchart of an example of a process 800B executed by a receiving UE while performing SL beam sweeping as described with reference to FIG. 7, in accordance with one aspect of the present disclosure. The process 800B will be described as being perform by a first UE (e.g., RX UE), which can be a device such as a UE 905 of FIG. 9.

In this example, a first UE (e.g., RX UE) can begin execution of the process 800B by receiving a unicast packet that was transmitted by a second UE (e.g., TX UE) using a preconfigured set of transmission serving beams (810B).

The first UE can continue execution of the process 800B by determining one or more transmission serving beams for transmitting an ACK or NACK to the second UE (820B). In other implementations, the first UE's determining at stage 820B can include determining to transmit an ACK or NACK to the second UE only in PSFCH corresponding to a transmission serving beam of the preconfigured set of transmission serving beams with the best SL RSRP. In some implementations, the first UE's determining at stage 820B can include determining to transmit an ACK or NACK to the second UE in PSFCH corresponding to each beam of the preconfigured set of transmission serving beams.

The first UE can continue execution of the process 800B by transmitting at least one ACK or NACK to the second UE in PSFCH (830B). In some implementations, the first UE's transmitting at stage 830B can include transmitting an ACK or NACK to the second UE in PSFCH corresponding to each beam of the preconfigured set of transmission serving beams. In other implementations, the first UE's transmitting at stage 830B can include transmitting an ACK or NACK to the second UE only in PSFCH corresponding to a transmission serving beam of the preconfigured set of transmission serving beams with the best SL RSRP.

In some implementations, the first UE can continue execution of the process 800B receiving a subsequent transmission from the second UE using a transmission beam determined based on the PSFCH used by the second UE to receive the ACK or NACK transmitted by the first UE.

FIG. 9 is a diagram of an example of a wireless communication system 900, according to some implementations. It is noted that the system of FIG. 9 is merely one example of a possible system, and that features of this disclosure may be implemented in other wireless communication systems.

The following description is provided for an example communication system 900 that operates in conjunction with fifth generation (5G) networks as provided by 3rd Generation Partnership Project (3GPP) technical specifications (TS). However, the example implementations are not limited in this regard and the described implementations may apply to other networks that may benefit from the principles described herein, such as 3GPP Long Term Evolution (LTE) networks, Wi-Fi or Worldwide Interoperability for Microwave Access (WiMaX) networks, and the like. Furthermore, other types of communication standards are possible, including future 3GPP systems (e.g., Sixth Generation (6G)) systems, IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

As shown, the communication system 900 includes a number of user devices. As used herein, the term “user devices” may refer generally to devices that are associated with mobile actors or traffic participants in the communication system 900, e.g., mobile (able-to-move) communication devices such as vehicles and pedestrian user equipment (PUE) devices. More specifically, the V2X communication system 900 includes two UEs 905 (UE 905-1 and UE 905-2 are collectively referred to as “UE 905” or “UEs 905”), two base stations 910 (base station 910-1 and base station 910-2 are collectively referred to as “base station 910” or “base stations 910”), two cells 915 (cell 915-1 and cell 915-2 are collectively referred to as “cell 915” or “cells 915”), and one or more servers 935 in a core network (CN) 940 that is connected to the Internet 945.

As shown, certain user devices may be able to conduct communications with one another directly, i.e., without an intermediary infrastructure device such as base station 910-1. As shown, UE 905-1 may conduct communications (e.g., V2X-related communications) directly with UE 905-2. Similarly, the UE 905-2 may conduct communications directly with UE 905-2. Such peer-to-peer communications may utilize a “sidelink” interface such as a PC5 interface. In certain implementations, the PC5 interface supports direct cellular communication between user devices (e.g., between UEs 905), while the Uu interface supports cellular communications with infrastructure devices such as base stations. For example, the UEs 905 may use the PC5 interface for a radio resource control (RRC) signaling exchange between the UEs. The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

The PC5 interface may alternatively be referred to as a SL interface and may include one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH). In some examples, the SL interface can operate on an unlicensed spectrum (e.g., in the unlicensed 5 Gigahertz (GHz) and 6 GHz bands) or a (licensed) shared spectrum.

In some implementations, UEs 905 may be physical hardware devices capable of running one or more applications, capable of accessing network services via one or more radio links 920 with a corresponding base station 910, and capable of communicating with one another via sidelink 925. Link 920 may allow the UEs 905 to transmit and receive data from the base station 910 that provides the link 920. The sidelink 925 may allow the UEs 905 to transmit and receive data from one another. The sidelink 925 between the UEs 905 may include one or more channels for transmitting information from UE 905-1 to UE 905-2 and vice versa and/or between UEs 905 and UE-type RSUs (not shown in FIG. 9) and vice versa.

In some implementations, the channels may include the Physical Sidelink Broadcast Channel (PSBCH), Physical Sidelink Control Channel (PSCCH), Physical Sidelink Discovery Channel (PSDCH), Physical Sidelink Shared Channel (PSSCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. The SCI in NR V2X is transmitted in two stages. The 1st-stage SCI in NR V2X is carried on the PSCCH while the 2nd-stage SCI is carried on the corresponding PSSCH. For example, 2-stage SCI can be used by applying the 1^{st} SCI for the purpose of sensing and broadcast communication, and the 2^{nd} SCI carrying the remaining information for data scheduling of unicast/groupcast data transmission.

In some implementations, the sidelink 925 is established through an initial beam pairing procedure. In this procedure, the UEs 905 identify (e.g., using a beam selection procedure) one or more potential beam pairs that could be used for the sidelink 925. A beam pair includes a transmitter beam from a transmitter UE (e.g., UE 905-1) to a receiver UE (e.g., UE 905-2) and a receiver beam from the receiver UE to the transmitter UE. In some examples, the UEs 905 rank the one or more potential beam pairs. Then, the UEs 905 select one of the one or more potential beam pairs for the sidelink 925, perhaps based on the ranking.

As stated, the air interface between two or more UEs 905 or between a UE 905 and a UE-type RSU (not shown in FIG. 9) may be referred to as a PC5 interface. To transmit/receive data to/from one or more eNBs 910 or UEs 905, the UEs 905 may include a transmitter/receiver (or alternatively, a transceiver), memory, one or more processors, and/or other like components that enable the UEs 905 to operate in accordance with one or more wireless communications protocols and/or one or more cellular communications protocols. The UEs 905 may have multiple antenna elements that enable the UEs 905 to maintain multiple links 920 and/or sidelinks 925 to transmit/receive data to/from multiple base stations 910 and/or multiple UEs 905. For example, as shown in FIG. 9, UE 905 may connect with base station 910-1 via link 920 and simultaneously connect with UE 905-2 via sidelink 925.

In some implementations, the UEs 905 are configured to use a resource pool for sidelink communications. A sidelink resource pool may be divided into multiple time slots, frequency channels, and frequency sub-channels. In some examples, the UEs 905 are synchronized and perform sidelink transmissions aligned with slot boundaries. A UE may be expected to select several slots and sub-channels for transmission of the transport block. In some aspects, a UE may use different sub-channels for transmission of the transport block across multiple slots within its own resource selection window, which may be determined using packet delay budget information.

In some implementations, the communication system 900 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, the UEs 905 are configured to perform sidelink beam failure recovery procedures. The V2X communication system 900 can enable or disable support of the sidelink beam failure recovery procedures in the UEs 905. More specifically, the V2X communication system 900 can enable or disable support per resource pool or per PC5-RRC configuration (which may depend on UE capability). In the sidelink beam failure recovery procedures, one of the UEs 905 is designated as a transmitter UE (e.g., UE 905-1) and the other UE is designated as a receiver UE (e.g., UE 905-2). For the purposes of this disclosure, a UE that detects a beam failure is designated as the receiver UE and the other UE is designated as the transmitter UE. More generally, a transmitter UE is the UE sending sidelink data, and the receiver UE is the UE receiving the sidelink data. Furthermore, although this disclosure describes a single transmitter UE and single receiver UE, the disclosure is not limited to this arrangement and can include more than one transmitter UE and/or receiver UE.

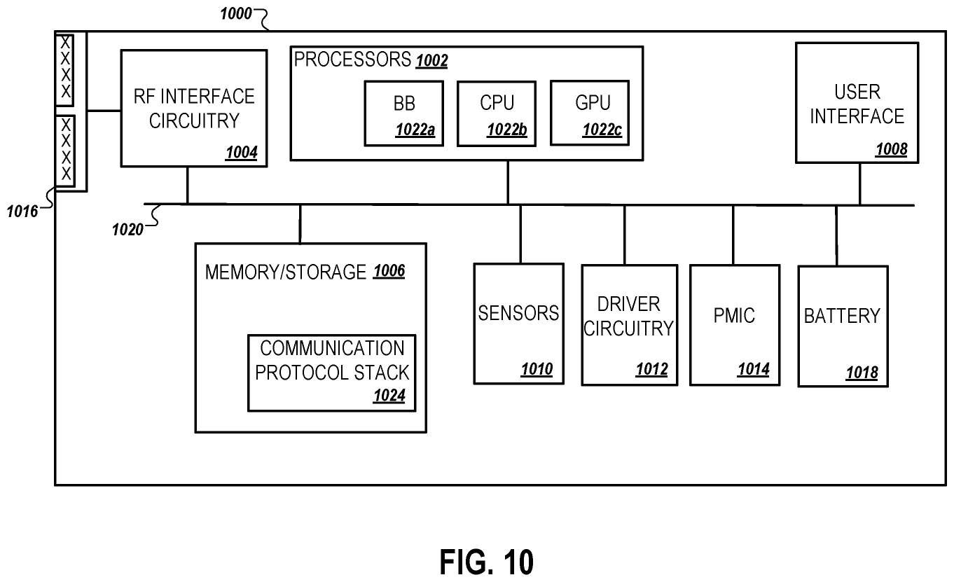

FIG. 10 is a block diagram of an example of user equipment (UE). The UE 1000 may be similar to and substantially interchangeable with UEs 905 of FIG. 9.

The UE 1000 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 1000 may include processors 1002, RF interface circuitry 1004, memory/storage 1006, user interface 1008, sensors 1010, driver circuitry 1012, power management integrated circuit (PMIC) 1014, antenna structure 1016, and battery 1018. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1020, which may represent any type of interface, input/output, bus (local, system, or expansion), transmission line, trace, optical connection, etc. that allows various circuit components (on common or different chips or chipsets) to interact with one another.

The processors 1002 may include processor circuitry such as, for example, baseband processor circuitry (BB) 1022A, central processor unit circuitry (CPU) 1022B, and graphics processor unit circuitry (GPU) 1022C. The processors 1002 may include any type of circuitry or processor circuitry that executes or otherwise operates computer-executable instructions, such as program code, software modules, or functional processes from memory/storage 1006 to cause the UE 1000 to perform operations as described herein.

In some implementations, the baseband processor circuitry 1022A may access a communication protocol stack 1024 in the memory/storage 1006 to communicate over a 3GPP compatible network. In general, the baseband processor circuitry 1022A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1004. The baseband processor circuitry 1022A may generate or process baseband signals or waveforms that carry information in 3GPP-compatible networks. In some implementations, the waveforms for NR may be based cyclic prefix OFDM “CP-OFDM” in the uplink or downlink, and discrete Fourier transform spread OFDM “DFT-S-OFDM”in the uplink.

The memory/storage 1006 may include one or more non-transitory, computer-readable media that includes instructions (for example, communication protocol stack 1024) that may be executed by one or more of the processors 1002 to cause the UE 1000 to perform various operations described herein. The memory/storage 1006 include any type of volatile or non-volatile memory that may be distributed throughout the UE 1000. In some implementations, some of the memory/storage 1006 may be located on the processors 1002 themselves (for example, L1 and L2 cache), while other memory/storage 1006 is external to the processors 1002 but accessible thereto via a memory interface. The memory/storage 1006 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1004 may include transceiver circuitry and radio frequency front module (RFEM) that allows the UE 1000 to communicate with other devices over a radio access network. The RF interface circuitry 1004 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1016 and proceed to filter and amplify (with a low-noise amplifier) the signal. The signal may be provided to a receiver of the transceiver that downconverts the RF signal into a baseband signal that is provided to the baseband processor of the processors 1002.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1016.

In various implementations, the RF interface circuitry 1004 may be configured to transmit/receive signals in a manner compatible with NR access technologies.

The antenna 1016 may include antenna elements to convert electrical signals into radio waves to travel through the air and to convert received radio waves into electrical signals. The antenna elements may be arranged into one or more antenna panels. The antenna 1016 may have antenna panels that are omnidirectional, directional, or a combination thereof to enable beamforming and multiple input, multiple output communications. The antenna 1016 may include microstrip antennas, printed antennas fabricated on the surface of one or more printed circuit boards, patch antennas, phased array antennas, etc. The antenna 1016 may have one or more panels designed for specific frequency bands including bands in FRI or FR2.

The user interface 1008 includes various input/output (I/O) devices designed to enable user interaction with the UE 1000. The user interface 1008 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1000.

The sensors 1010 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1012 may include software and hardware elements that operate to control particular devices that are embedded in the UE 1000, attached to the UE 1000, or otherwise communicatively coupled with the UE 1000. The driver circuitry 1012 may include individual drivers allowing other components to interact with or control various input/output (I/O) devices that may be present within, or connected to, the UE 1000. For example, driver circuitry 1012 may include a display driver to control and allow access to a display device, a touchscreen driver to control and allow access to a touchscreen interface, sensor drivers to obtain sensor readings of sensor circuitry 1028 and control and allow access to sensor circuitry 1028, drivers to obtain actuator positions of electro-mechanic components or control and allow access to the electro-mechanic components, a camera driver to control and allow access to an embedded image capture device, audio drivers to control and allow access to one or more audio devices.

The PMIC 1014 may manage power provided to various components of the UE 1000. In particular, with respect to the processors 1002, the PMIC 1014 may control power-source selection, voltage scaling, battery charging, or DC-to-DC conversion.

In some implementations, the PMIC 1014 may control, or otherwise be part of, various power saving mechanisms of the UE 1000 including DRX as discussed herein. A battery 1018 may power the UE 1000, although in some examples the UE 1000 may be mounted deployed in a fixed location, and may have a power supply coupled to an electrical grid. The battery 1018 may be a lithium ion battery, a metal-air battery, such as a zinc-air battery, an aluminum-air battery, a lithium-air battery, and the like. In some implementations, such as in vehicle-based applications, the battery 1018 may be a typical lead-acid automotive battery.

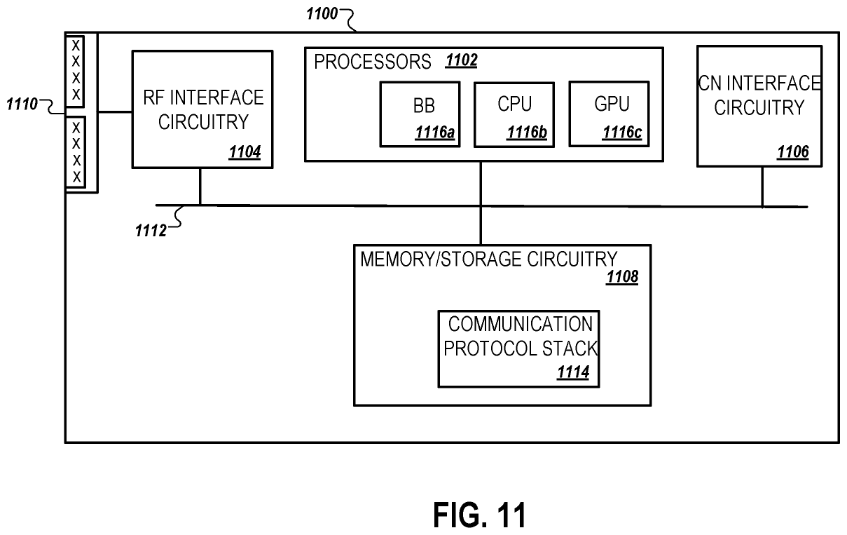

FIG. 11 is a block diagram of an example of an access node. FIG. 11 illustrates an access node 1100 (e.g., a base station or gNB), in accordance with some implementations. The access node 1100 may be similar to and substantially interchangeable with base stations 910. The access node 1100 may include processors 1102, RF interface circuitry 1104, core network (CN) interface circuitry 1106, memory/storage circuitry 1108, and antenna structure 1110.

The components of the access node 1100 may be coupled with various other components over one or more interconnects 1112. The processors 1102, RF interface circuitry 1104, memory/storage circuitry 1108 (including communication protocol stack 1114), antenna structure 1110, and interconnects 1112 may be similar to like-named elements shown and described with respect to FIG. 11. For example, the processors 1102 may include processor circuitry such as, for example, baseband processor circuitry (BB) 1116A, central processor unit circuitry (CPU) 1116B, and graphics processor unit circuitry (GPU) 1116C.

The CN interface circuitry 1106 may provide connectivity to a core network, for example, a 5th Generation Core network (5GC) using a 5GC-compatible network interface protocol such as carrier Ethernet protocols, or some other suitable protocol. Network connectivity may be provided to/from the access node 1100 via a fiber optic or wireless backhaul. The CN interface circuitry 1106 may include one or more dedicated processors or FPGAs to communicate using one or more of the aforementioned protocols. In some implementations, the CN interface circuitry 1106 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1100 that operates in an NR or 5G system (for example, a gNB), and the term “E-UTRAN node” or the like may refer to an access node 1100 that operates in an LTE or 4G system (e.g., an eNB). According to various implementations, the access node 1100 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1100 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 1100; a MAC/PHY split wherein RRC, PDCP, RLC, and MAC layers are operated by the CRAN/vBBUP and the PHY layer is operated by the access node 1100; or a “lower PHY” split wherein RRC, PDCP, RLC, MAC layers and upper portions of the PHY layer are operated by the CRAN/vBBUP and lower portions of the PHY layer are operated by the access node 1100.

In V2X scenarios, the access node 1100 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S. C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### EXAMPLES

Example 1 is a method for establishing a communication link, the method comprising transmitting, by a first UE, a direct communication request to a second UE using a preconfigured set of transmission serving beams; receiving, by the first UE, a direct security mode message from the second UE, wherein the direct security mode message was transmitted, by the second UE, using a resource associated with a particular transmission serving beam of the set of transmission serving beams; and transmitting, by the first UE, a transmission using a transmission serving beam based on the resource associated with the particular transmission serving beam.

Example 2 may include the subject matter of example 1, wherein an association between the preconfigured set of transmission serving beams and a resource used, by the first UE, to receive direct communication acceptance is pre-configured.

Example 3 may include the subject matter of any of examples 1-2, wherein the particular transmission serving beam of the set of transmission serving beams selected by the second UE is selected based on a sidelink reference signal received power (SL RSRP) associated with each of the transmission serving beams.

Example 4 may include the subject matter of any of examples 1-3, wherein the particular transmission serving beam of the set of transmission serving beams selected by the second UE is selected based on the particular transmission serving beam having the highest sidelink reference signal received power (SL RSRP) among RSRP of transmission serving beams in the set.

Example 5 may include the subject matter of any of examples 1-4, wherein resource associated with the particular transmission serving beam of the set of transmission serving beams is selected by the second UE.

Example 6 is one or more processors comprising circuitry to execute one or more instructions that, when executed, cause user equipment (UE) to perform the operations of any of examples 1-5.

Example 7 is a user equipment (UE) that includes one or more processors; and one or more memory devices storing instructions that, when executed, cause the one or more processors to perform the operations of any of examples 1-5.

Example 8 is a method for establishing a communication link, the method comprising receiving, by a first UE, a direct communication request transmitted by a second UE using a preconfigured set of transmission serving beams; selecting, by the first UE, a particular transmission serving beam from a set of transmission serving beams for use in transmitting a direct security mode message to the second UE; and transmitting, by the first UE, the direct security mode message to the second UE using a resource associated with the selected transmission serving beam.

Example 9 may include the subject matter of example 8, the method further comprising receiving, by the first UE, a transmission on a transmission serving beam from the second UE that was determined based on the resource used, by the first UE, to transmit the direct security mode message.

Example 10 may include the subject matter of any of examples 8-9, wherein selecting, by the first UE, a particular transmission serving beam from a set of transmission serving beams for use in transmitting a direct security mode message to the second UE comprises selecting, by the first UE, a particular transmission serving beam from the set of transmission serving beams for use in transmitting the direct security mode message based on a sidelink reference signal received power (SL RSRP) associated with each of the transmission serving beams.

Example 11 may include the subject matter of any of examples 8-10, wherein selecting, by the first UE, a particular transmission serving beam from a set of transmission serving beams for use in transmitting a direct security mode message to the second UE comprises selecting, by the first UE, a particular transmission serving beam from the set of transmission serving beams for use in transmitting the direct security mode message based on the particular transmission serving beam having the best sidelink reference signal received power (RSRP).

Example 12 may include the subject matter of example 11, wherein the particular transmission serving beam having the best SL RSRP is the particular transmission serving beam of the set of transmission serving beams having the highest SL RSRP.

Example 13 is one or more processors comprising circuitry to execute one or more instructions that, when executed, cause user equipment (UE) to perform the operations of any of examples 8-12.

Example 14 is user equipment (UE) comprising one or more processors; and one or more memory devices storing instructions that, when executed, cause the one or more processors to perform the operations of any of examples 8-12.

1-14. (canceled)

15. One or more processors configured to, when executing instructions stored in a memory, perform operations comprising:
instructing radio frequency (RF) circuitry to transmit a direct communication request to a user equipment (UE) using a preconfigured set of transmission serving beams;
receiving, via the RF circuitry, a direct security mode command from the UE using a resource associated with a particular transmission serving beam of the preconfigured set of transmission serving beams; and
instructing the RF circuitry to transmit a direct security mode complete message to the UE using the particular transmission serving beam.

16. The one or more processors of claim 15, wherein an association between the particular transmission serving beam and the resource used to receive the direct security mode complete message is preconfigured.

17. The one or more processors of claim 15, wherein the particular transmission serving beam is selected based at least on a sidelink reference signal received power (SL-RSRP) associated with each transmission serving beam in the preconfigured set of transmission serving beams.

18. The one or more processors of claim 15, wherein the particular transmission serving beam is selected based at least on the particular transmission serving beam having a highest sidelink reference signal received power (SL-RSRP) among the preconfigured set of transmission serving beams.

19. The one or more processors of claim 15, wherein the particular transmission serving beam is selected based at least on quality of service (QOS) parameters associated with the preconfigured set of transmission serving beams.

20. The one or more processors of claim 15, the operations further comprising instructing the RF circuitry to transmit a sidelink message to the UE after receiving, via the RF circuitry, a direct communication accept message in response to the direct communication request.

21. The one or more processors of claim 20, the operations further comprising establishing a PC5 sidelink (PC5-S) connection with the UE in accordance with the direct communication accept message.

22. One or more processors configured to, when executing instructions stored in a memory, perform operations comprising:
receiving, via radio frequency (RF) circuitry, a direct communication request transmitted by a user equipment (UE) using a preconfigured set of transmission serving beams;
selecting a transmission serving beam from the preconfigured set of transmission serving beams; and
instructing the RF circuitry to transmit a direct security mode message to the UE using a resource associated with the selected transmission serving beam.

23. The one or more processors of claim 22, the operations further comprising:
receiving, via the RF circuitry, a direct security mode complete message transmitted by the UE using the selected transmission serving beam associated with the resource used to transmit the direct security mode message.

24. The one or more processors of claim 22, wherein selecting the particular transmission serving beam from the preconfigured set of transmission serving beams comprises:
selecting the particular transmission serving beam based at least on a sidelink reference signal received power (SL-RSRP) associated with each transmission serving beam in the preconfigured set of transmission serving beams.

25. The one or more processors of claim 22, wherein selecting the particular transmission serving beam from the preconfigured set of transmission serving beams comprises:
selecting the particular transmission serving beam based at least on the particular transmission serving beam having a best sidelink reference signal received power (SL-RSRP) among the preconfigured set of transmission serving beams.

26. The one or more processors of claim 25, wherein the particular transmission serving beam is selected based at least on quality of service (QOS) parameters associated with the preconfigured set of transmission serving beams.

27. The one or more processors of claim 22, the operations further comprising receiving, via the RF circuitry, a sidelink message from the UE after instructing the RF circuitry to transmit a direct communication accept message in response to the direct communication request.

28. The one or more processors of claim 27, the operations further comprising establishing a PC5 sidelink (PC5-S) connection with the UE in accordance with the direct communication accept message.

29. A method comprising:
transmitting a direct communication request to a user equipment (UE) using a preconfigured set of transmission serving beams;
receiving a direct security mode command from the UE using a resource associated with a particular transmission serving beam of the preconfigured set of transmission serving beams; and
transmitting a direct security mode complete message to the UE using the particular transmission serving beam.

30. The method of claim 29, wherein an association between the particular transmission serving beam and the resource used to receive the direct security mode complete message is preconfigured.

31. The method of claim 29, wherein the particular transmission serving beam is selected based at least on a sidelink reference signal received power (SL-RSRP) associated with each transmission serving beam in the preconfigured set of transmission serving beams.

32. The method of claim 29, wherein the particular transmission serving beam is selected based at least on the particular transmission serving beam having a highest sidelink reference signal received power (SL-RSRP) among the preconfigured set of transmission serving beams.

33. The method of claim 29, wherein the particular transmission serving beam is selected based at least on quality of service (QOS) parameters associated with the preconfigured set of transmission serving beams.

34. The method of claim 29, further comprising transmitting a sidelink message to the UE after receiving a direct communication accept message in response to the direct communication request.
